(19) United States
(12) Patent Application Publication
(10) Pub. No.: US 2006/0217148 A1
(43) Pub. Date: Sep. 28, 2006

(54) Camera phone with large sensor

(75) Inventor: Ronald S. Cok, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/087,320

(22) Filed: Mar. 23, 2005

(51) Int. Cl. H04M 1/00

(52) U.S. Cl. 455/556.1; 455/575.1

(57) ABSTRACT

A camera phone having an integrated camera that includes a body having a thin portion located at the center and first end of the body and a thick portion contiguous with the main portion located at a second end. The thick portion has a thickness at least 2.5% greater than the maximum thickness of the main portion. A digital imaging sensor is provided substantially in the thick portion. An optional second thin portion may be provided adjacent the first thin portion.

### FIELD OF THE INVENTION

The present invention relates to camera phones, and more particularly to the use of large sensors in the camera phone.

### BACKGROUND OF THE INVENTION

Cell phones, portable telephones wirelessly connected to a cellular communication network, are widely used in many countries and the technology supporting such devices is well developed and moving forward rapidly. In recent years, the incorporation of cameras into cell phones has become popular and is well known in the prior art. For example, GB2396994 A entitled “Transceiver with image capture device” describes a camera mounted in a mobile telephone as does WO2004059965 A1 entitled “Transceiver with Image Capture Device”.

A variety of configurations are known, including cell phones with two components that open or close about a rotatable hinge at one end. For example, US20040166829 A1 entitled “Collapsible cellular communication terminal having a camera having photographing control function and photographing control method in the terminal” discloses a folding mobile communications terminal that has a photographing function and is openable/closable. This folding mobile communications terminal detects whether the folds are closed, and disables the photographing function if the folds are closed.

Cell phones having displays for viewing captured images and rotating or sliding elements are also described in the patent literature. EP 1357726 A1 entitled “Portable telephone having a rotating display and two cameras” describes a foldable portable telephone set including a lower unit having a console portion, an upper unit having a display portion, and a hinge portion for joining the lower unit to the upper unit so as to enable to open and close them, the upper unit consists of a display portion unit, a supporting portion unit, and a rotating and sliding mechanism.

Camera phones typically include imaging modules that serve as the image acquisition device. Sensors, typically CMOS, are packages with a lens element and mount to form a complete unit. Because size and power are important constraints in camera phones, the technical capabilities of the components are severely constrained. Many designs of such modules are known in the art and commercially available. For example, US patent application 20040233319 A1 entitled “Image sensing module” describes such an image sensing module that includes a circuit board, an image sensor mounted on and coupled electrically to the circuit board, an optical lens unit mounted on the circuit board and operably associated with the image sensor such that the image sensor acquires an object image through the optical lens unit and generates an electrical output corresponding to the object image, and an electrical connector mounted on the circuit board and having an input port coupled electrically to the circuit board so as to receive the electrical output of the image sensor, and an output port adapted to be coupled electrically to a ribbon cable. US patent application 20040227838 A1 entitled “Optical system and image pickup apparatus” describes an alternative design.

Because of the size constraints of the camera phones, the optical elements and designs of the imaging modules are limited. US patent application 20040212901 A1 entitled “Lens system” describes a compact telecentric design. However, size is a significant issue for all image modules and lens designs for a camera phone.

EP 1267576 A2 entitled “Portable phone with camera: proposes that a camera be mounted in the rotatable hinge connecting two portions of the camera phone. However, such an arrangement still severely limits the available space for the camera phone.

In an effort to address the size constraints, various inventors have proposed a variety of configurations. US patent application 20040228075 A1 entitled “Mobile terminal device with camera” describes a mobile phone device with a camera comprises a connecting section which connects a first casing and a second casing and a camera module which is disposed in the connecting section. In this way a sufficient length for the optical axis in the camera module may be obtained. However, this design requires that a user rotate the two halves of the camera phone about the optical axis to open or close it. Hence, the usability of this approach is questionable.

In an effort to improve the quality of images acquired by camera phones, manufacturers have increased the resolution of the sensors employed in the camera phone. While this increases the number of pixels captured by the sensor, it does not improve the quality of the information captured. The quality of information captured depends on the physical size of the pixel since a larger pixel will capture more photons and improve the signal-to-noise ratio of the sensors. If the resolution of the sensor is increased while the physical size of the sensor is constant, pixel size itself is decreased and the relative noise level increased. Therefore, such sensors tend to have poor low-light or high-speed performance. There is a need therefore for an improved camera phone having improved image quality in low-light and high-speed conditions.

### SUMMARY OF THE INVENTION

In accordance with one embodiment there is provided a portable telephone having an integrated camera, comprising:

a) a body having a thin portion located at the center and first end of the body and a thick portion contiguous with the main portion located at a second end and wherein the thick portion has a thickness at least 2.5% greater than the maximum thickness of the main portion; and

b) a camera including a digital imaging sensor and a lens located in the thick portion.

In accordance with another aspect of the present invention there is provided a portable telephone having an integrated camera, comprising:

a) a body having a thin portion located at the center and first end of the body and a thick portion contiguous with the main portion located at a second end and wherein the thick portion has a thickness at least 10% greater than the maximum thickness of the main portion;

b) a second thin portion rotatably connected with the thin portion at the first end; and

c) a camera including a digital imaging sensor and a lens located in the thick portion.

### ADVANTAGES

The advantages of this invention are a camera phone having improved image quality and usability. These and other aspects, objects, features and advantages of the present invention will be more clearly understood and appreciated from a review of the following detailed description of the preferred embodiments and appended claims and by reference to the accompanying drawings.

### BRIEF DESCRIPTION OF THE DRAWINGS

In the detailed description of the preferred embodiments of the invention presented below, reference is made to the accompanying drawings in which:

FIG. 1 is a perspective drawing of one embodiment of the present invention;

FIG. 2 an alternative view of FIG. 1;

FIG. 3a is a perspective drawing of an alternative embodiment of the present invention having two components rotatably joined;

FIG. 3b is a perspective drawing of FIG. 3a with the components rotated;

FIG. 4 is a perspective drawing of FIG. 3a with the components rotated approximately 270 degrees;

FIGS. 5a-5c are perspective drawings of alternative arrangements of sensors and lenses according to various embodiments of the present invention;

FIG. 6 illustrates an optical path of yet another embodiment of the present invention;

FIG. 7 is a side view illustration of the embodiment of FIGS. 1, 2, 3a, 3b, and 4;

FIG. 8 is a side view illustration of an alternative embodiment of the present invention employing a lens cover;

FIGS. 9a and 9b are side views illustrating the use of zoom lenses according to another alternative embodiment of the present invention;

FIG. 10 is a partial side view of yet another modified embodiment of the present invention;

FIGS. 11a and 11b are side views illustrating yet still another modified embodiment of the present invention.

### DETAILED DESCRIPTION OF THE INVENTION

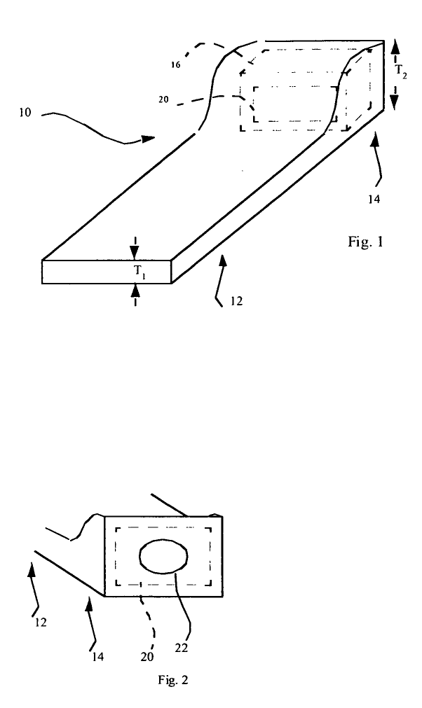

Referring to FIGS. 1 and 2, one embodiment of a camera phone according to the present invention comprises a body 10 having a thin portion 12 with a thickness T₁ located at the center and first end of the body and a thick portion 14 contiguous with the thin portion 12 located at a second end and wherein the thick portion 14 has a thickness T₂ greater than the maximum thickness T₁ of the main thin portion 12; and a camera 16 including a digital imaging sensor 20 and a lens 22 located in the thick portion 14. The sensor is typically planar and comprises a silicon integrated circuit and is generally, but not always, a CMOS device. Preferably the thickness T₂ is at least 10% greater than T₁. In the particular embodiment illustrated, T₂ is about twice as thick as T₁.

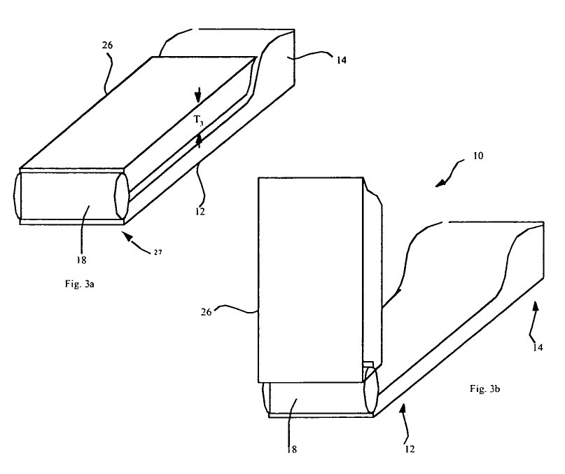

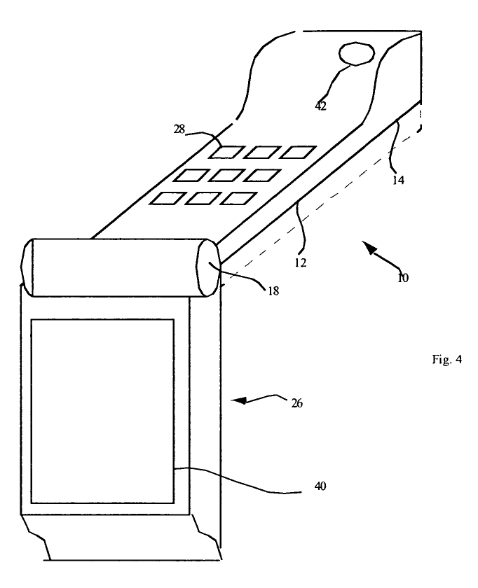

Referring to FIG. 3a, in a second embodiment of the present invention, a second thin portion 26 is rotatably connected with the thin portion 12 at the first end 27, for example by a hinge 18. The thickness T₃ of the second thin portion 26 is less than or equal to the thickness T₁ of the thin portion 12. In a preferred arrangement, the thick portion 14 has a thickness substantially equal to the sum of the thicknesses of T₁ and T₃ of the thin portion 12 and second thin portion 26. As shown in FIGS. 3 and 4, in a preferred arrangement, the second thin portion 26 does not extend over the thick portion 14 so that the overall thickness of the camera phone is not increased. In this way, greater space may be provided in the thick portion 14 for an imaging module including the sensor 20 and a lens 22 or multiple lens elements without actually increasing the total width of the camera phone. In some commercial camera phones, each thin portion 12, 26 is approximately one cm thick and the available space for an optical path is therefore limited to one cm. According to the present invention, an optical path 30 having twice the distance is provided. Referring to FIG. 3b, the second thin portion 26 may be rotated about the hinge 18 to open the camera phone, using designs well known in the art and commercially available.

The thin portions 12 and 26 of the camera phone are employed to support a user interface, for example including selection buttons 28 and a display 40, which are conventionally found on camera phones. Referring to FIG. 4, in a further embodiment of the present invention, the camera phone includes a button or other shutter trigger mechanism 42 associated with lens 22 to acquire an image. Such a shutter trigger mechanism 42 may be electronic or mechanical and may be mounted on the thick portion 14, as shown, or on the thin portion 12, or on the second thin portion 26. As shown in FIG. 4, one way to provide a usable image display interface with this arrangement is to open the camera by rotating the second thin portion approximately 270 degrees and hold it with the display 40 facing a user and the lens and sensor (as illustrated in FIGS. 1 and 2) toward the scene to be captured. Alternatively the thin portion can be mounted in any appropriate manner such that it can rotate/move to a position such that when the lens is directed to an object the display 40 is facing the user as shown by the dash lines. The shutter trigger mechanism may then be triggered to capture the scene. In this arrangement, the display 40 is located in the second thin portion facing the thin portion when the thin and second thin portions 12 and 26 are not rotated with respect to each other.

In a typical camera phone of the prior art, the body of the camera phone has a length greater than its width, and a width greater than its thickness. In the present invention, a variety of arrangements may be employed for the sensor and lenses in the imaging module. Referring to FIG. 5a, in one arrangement, the sensor has a planar surface arranged substantially perpendicular to a line 60 parallel to the extent of the length of the portable telephone. In this arrangement, an image is captured by aiming the end face of the camera phone toward the scene to be captured. The lens is located on the end face of the camera phone. Referring to FIG. 5b, in a second arrangement, the sensor has a planar surface arranged substantially perpendicular to a line 62 parallel to the extent of the width of the portable telephone. In this arrangement, an image is captured by aiming the side face of the camera phone toward the scene to be captured. The lens 22 is located on a side of the camera phone.

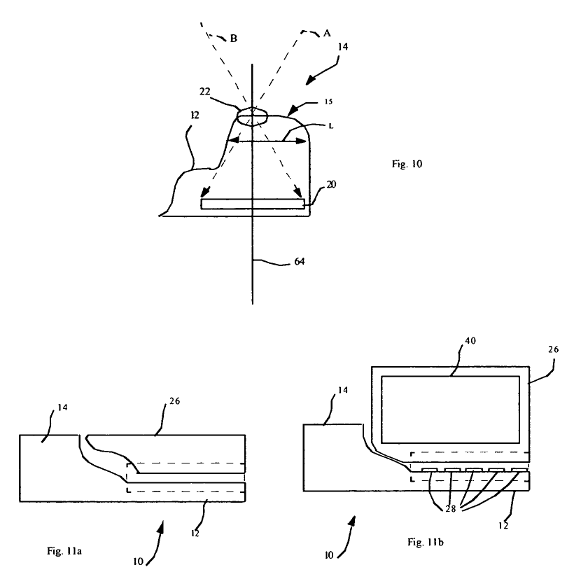

Referring to FIG. 5c, in a third arrangement, the sensor has a planar surface arranged substantially perpendicular to a line 64 parallel to the extent of the depth of the portable telephone. In this arrangement, an image is captured by aiming the front or back face of the camera phone toward the scene to be captured. The lens 22 is located on the front (as shown) or back of the camera phone. As shown in FIG. 10, the sensor itself can be larger than the thick end 14 thereby maximizing the space available for the sensor while still maintaining a small camera profile. It is only necessary that light passing through the lens 22 be able to expose the full available imaging surface of the sensor as illustrated by light rays A and B. The embodiment of FIG. 10 utilizes a portion of thin portion 12 which can be used to provide a larger sensor 20 when the lens 22 is provided on the front side 15 of the thick portion 14.

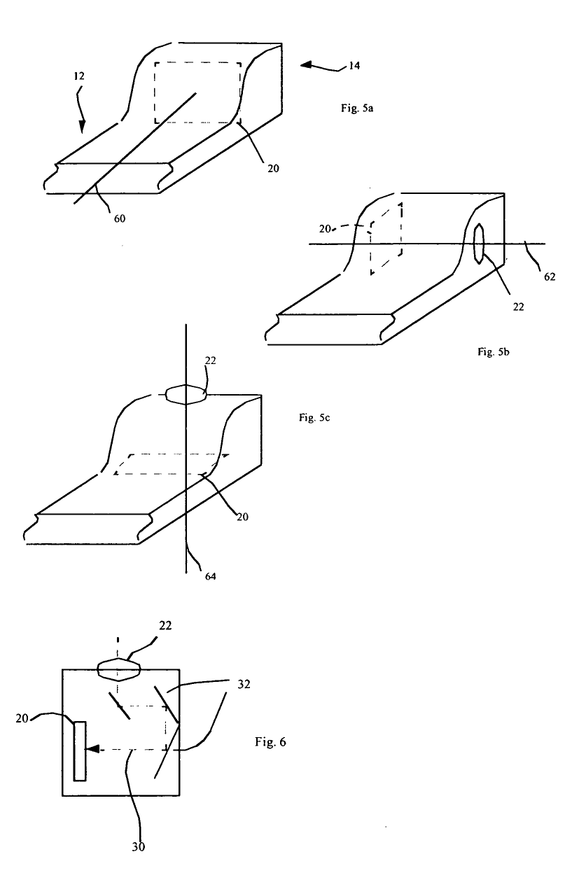

Alternative optical designs are possible using folded and unfolded optical paths 30 (see FIGS. 6-9). For example, as shown in FIG. 6, a sensor 20 may be located adjacent to and parallel with a side of a camera phone (as illustrated in FIG. 5b) but with a lens 22 located on the end or top of the camera phone (as illustrated in FIGS. 5a and 5c). Curved reflective or aspheric transmissive elements 32 may be employed in optical path 30, as is known in the art, to optimize the image quality and minimize the size of the imaging module.

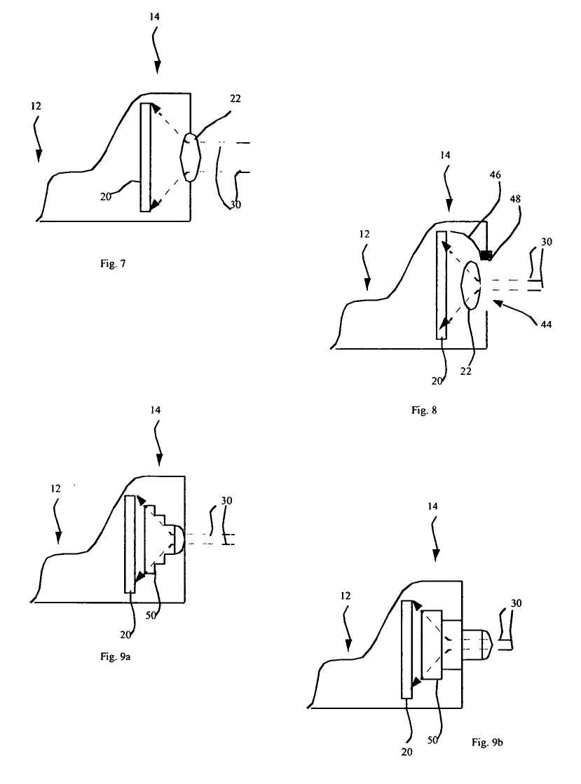

A further advantage of the present invention is that the thick portion 14 of the camera phone may be employed to house additional devices. For example, the thick portion 14 of the camera phone may be employed to house a microphone or speaker to provide conventional audio functionality. Alternatively or in addition, a flexible lens cover may be employed to protect the lens. Referring to FIG. 7, a design suitable for the embodiments shown in FIGS. 1 through 5a, that does not include a protective lens cover is illustrated. In this case, the lens is exposed to the environment and is subject to damage, for example scratches. FIG. 8 illustrates an alternative employing a flexible lens cover 46 with a handle 48 that slides along a track in an opening 44 to expose or protect the lens 22. The flexible lens cover may be made of a flexible material or may be a jointed series of inflexible elements (as found in a roll-top desk). The lens cover may be mechanically or electrically operated.

Referring to FIGS. 9a and 9b, the thick portion 14 may be employed to improve image quality and expand the range of scenes that may be captured by a camera phone, by housing more complex optical systems. For example, an optical zoom 50 may be located in the housing. As illustrated in FIG. 9a, the optical zoom is retracted; as illustrated in FIG. 9b, it is extended.

Referring to FIGS. 11a and 11b there is illustrated an embodiment wherein the thin portion 26 rotates about hinge 8 along the length of the body 10 revealing display 40 and selection buttons 28 on thin portion 12.

According to preferred embodiments of the present inventions, a portable telephone having an integrated camera comprises a body having a thin portion located at the center and first end of the body and a thick portion contiguous with the main portion located at a second end and wherein the thick portion has a thickness T₂ at least 2.5% greater than the maximum thickness T₁ of the main portion; and a camera including a digital imaging sensor and a lens located in the thick portion. For example, a sensor having an active area of 16 mm by 10 mm having a 1,000 by 1,000 resolution (or 10 microns per pixel in the short dimension) can have a noticeably improved performance by increasing either the resolution 5% in either or both dimensions of the sensor active area, resulting in an increase of up to 5% in the physical size of the sensor cavity in at least one dimension. Hence, a thick portion T₂ at least 5% thicker than the thin portion T₁ can enable the use of a larger sensor having noticeably improved performance. Alternatively, increasing the area of the pixels by 5% results in a noticeable decrease in signal to noise and an increase in an edge length of the sensor active area of 2.5% and corresponding increase of up to 2.5% in the physical size of the sensor cavity in at least one dimension. Hence, a thick portion having a thickness T₂ at least 2.5% thicker than the thickness T₁ of the thin portion can enable the use of a larger sensor having improved performance.

In some situations a 5% improved performance may not be sufficient. Thus, further improved results may be obtained by having the thickness T₂ of the thick portion 14 be at least 10%, preferably 25%, greater than the thickness T₁ of the first thin portion 12. If the thickness T₁ of the first thin portion 12 and the thickness T₃ of the second thin portion 26 are substantially equal, then the thickness T₂ of the thick portion 14 would be about 100% greater than the thickness T₁ of the thin portion 12.

The present invention provides a means for providing an increased size of sensor and more complex optical system in a camera phone with increasing the overall thickness of the camera phone and thereby provides improved image quality without decreasing usability of the camera phone. The invention has been described in detail with particular reference to certain preferred embodiments thereof, but it will be understood that variations and modifications can be effected within the spirit and scope of the invention.

### Parts List

10 camera phone body
12 thin portion
14 thick portion
15 front side
16 camera
18 hinge
20 sensor
22 lens
26 second thin portion
27 first end
28 buttons
30 optical path
32 curved reflective/aspheric transmissive elements
40 display
42 shutter trigger mechanism
44 opening
46 lens cover
48 handle
50 zoom lens
60 line
62 line
64 line

1. A portable telephone having an integrated camera, comprising:
a) a body having a thin portion located at the center and first end of the body and a thick portion contiguous with the main portion located at a second end and wherein the thick portion has a thickness at least 2.5% greater than the maximum thickness of the main portion; and
b) a camera including a digital imaging sensor and a lens located in the thick portion.

2. The portable telephone of claim 1, further including a second thin portion rotatably connected with the thin portion at the first end.

3. The portable telephone of claim 2, wherein the thick portion has a thickness greater than the second thin portion.

4. The portable telephone of claim 2, wherein the thick portion has a thickness substantially equal to or less than the thickness of the thin portion and the second thin portion together.

5. The portable telephone of claim 1, wherein the second thin portion has a length equal to or less than the main portion.

6. The portable telephone of claim 1, wherein the first thin portion has a length equal to or less than the second thin portion.

7. The portable telephone of claim 1, wherein the length of the main portion is greater than its width, and the width of the main portion is greater than its thickness.

8. The portable telephone of claim 1, wherein the sensor has a planar surface arranged substantially perpendicular to a line parallel to the extent of the length of the portable telephone.

9. The portable telephone of claim 8, wherein the lens is located at the end face of the thick portion.

10. The portable telephone of claim 1, wherein the sensor has a planar surface arranged substantially perpendicular to a line parallel to the extent of the depth of the portable telephone.

11. The portable telephone of claim 10, wherein the lens is located on the front or back face of the thick portion.

12. The portable telephone of claim 1, wherein the sensor has a planar surface arranged substantially perpendicular to a line parallel to the extent of the width of the portable telephone.

13. The portable telephone of claim 12, wherein the lens is located on a side face of the thick portion.

14. The portable telephone of claim 10, wherein the sensor is a CMOS sensor.

15. The portable telephone of claim 1, optical path of the camera is a folded path incorporating a mirror.

16. The portable telephone of claim 2, wherein the rotation of the second thin portion with respect to the thin portion is greater than 180 degrees.

17. The portable telephone of claim 2, further including a shutter trigger mechanism for acquiring an image located in the main or thick portion.

18. The portable telephone of claim 2, further including a display located in the second thin portion facing the thin portion when the thin and second thin portions are not rotated with respect to each other.

19. The portable telephone of claim 16, wherein the second thin portion is rotated and is located facing a user, the sensor in the thick portion is facing a scene, and an image is acquired.

20. The portable telephone of claim 1, further including a microphone or speaker located in the thick portion.

21. The portable telephone of claim 1, further including an optical zoom element located in the thick portion.

22. The portable telephone of claim 1, further including a flexible, retractable lens cover located in the thick portion.

23. The portable telephone of claim 1 wherein the sensor extends into at least a portion of the thin portion.

24. The portable telephone of claim 23 wherein the sensor lies parallel to the flat side of said telephone.

25. The portable telephone of claim 23 wherein the second thin portion covers the lens in the non use state.

26. The portable telephone of claim 23 wherein the thin portion rotates such that when the lens is directed to an object for capturing an image the display in the phone is facing the user.

27. The portable telephone of claim 1 wherein the thick portion has a thickness at least 10% greater than the maximum thickness of the main portion.

28. The portable telephone of claim 1 wherein the thick portion has a thickness at least 25% greater than the maximum thickness of the main portion.

29. The portable telephone of claim 1 wherein the thick portion has a thickness of about twice the thickness of the main portion.

30. A portable telephone having an integrated camera, comprising:
a) a body having a thin portion located at the center and first end of the body and a thick portion contiguous with the main portion located at a second end and wherein the thick portion has a thickness at least 10% greater than the maximum thickness of the main portion;
b) a second thin portion rotatably connected with the thin portion at the first end; and
c) a camera including a digital imaging sensor and a lens located in the thick portion.

31. The portable telephone of claim 30 wherein the second thin portion has a length equal to or less than the main portion.

32. The portable telephone of claim 30, wherein the first thin portion has a length equal to or less than the second thin portion.

33. The portable telephone of claim 30, wherein the length of the main portion is greater than its width, and the width of the main portion is greater than its thickness.

34. The portable telephone of claim 30, wherein the sensor has a planar surface arranged substantially perpendicular to a line parallel to the extent of the length of the portable telephone.

35. The portable telephone of claim 31, wherein the lens is located at the end face of the thick portion.

36. The portable telephone of claim 30, wherein the sensor has a planar surface arranged substantially perpendicular to a line parallel to the extent of the depth of the portable telephone.

37. The portable telephone of claim 36, wherein the lens is located on the front or back face of the thick portion.

38. The portable telephone of claim 30, wherein the sensor has a planar surface arranged substantially perpendicular to a line parallel to the extent of the width of the portable telephone.

39. The portable telephone of claim 39, wherein the lens is located on a side face of the thick portion.

40. The portable telephone of claim 36, wherein the sensor is a CMOS sensor.

41. The portable telephone of claim 30, optical path of the camera is a folded path incorporating a mirror.

42. The portable telephone of claim 30, wherein the rotation of the second thin portion with respect to the thin portion is greater than 180 degrees.

43. The portable telephone of claim 30, further including a shutter trigger mechanism for acquiring an image located in the main or thick portion.

44. The portable telephone of claim 30, further including a display located in the second thin portion facing the thin portion when the thin and second thin portions are not rotated with respect to each other.

45. The portable telephone of claim 42, wherein the second thin portion is rotated and is located facing a user, the sensor in the thick portion is facing a scene, and an image is acquired.

46. The portable telephone of claim 30, further including a microphone or speaker located in the thick portion.

47. The portable telephone of claim 30, further including an optical zoom element located in the thick portion.

48. The portable telephone of claim 30, further including a flexible, retractable lens cover located in the thick portion.

49. The portable telephone of claim 31 wherein the sensor extends into at least a portion of the thin portion.

50. The portable telephone of claim 49 wherein the sensor lies parallel to the flat side of said telephone.

51. The portable telephone of claim 49 wherein the second thin portion covers the lens in the non use state.

52. The portable telephone of claim 49 wherein the thin portion rotates such that when the lens is directed to an object for capturing an image the display in the phone is facing the user.

53. The portable telephone of claim 30 wherein the thick portion has a thickness at least 10% greater than the maximum thickness of the main portion.

54. The portable telephone of claim 30 wherein the thick portion has a thickness at least 25% greater than the maximum thickness of the main portion.

55. The portable telephone of claim 30 wherein the thick portion has a thickness of about twice the thickness of the main portion.
